(19) United States
(12) Patent Application Publication
(10) Pub. No.: US 2016/0117694 A1
(43) Pub. Date: Apr. 28, 2016

(54) CLIENT MANAGEMENT SYSTEM

(71) Applicants: Chet Brandenburg, Pismo Beach, CA (US); Scott Lewis, San Luis Obispo, CA (US); Marianne Conner, Atascadero, CA (US); Josh Curry, Templeton, CA (US)

(72) Inventors: Chet Brandenburg, Pismo Beach, CA (US); Scott Lewis, San Luis Obispo, CA (US); Marianne Conner, Atascadero, CA (US); Josh Curry, Templeton, CA (US)

(21) Appl. No.: 14/920,843

(22) Filed: Oct. 22, 2015

Related U.S. Application Data
(60) Provisional application No. 62/067,550, filed on Oct. 23, 2014.

(51) Int. Cl. G06Q 30/02; H04L 12/58; G06F 3/0484; H04L 29/08

(52) U.S. Cl. CPC G06Q 30/0201; H04L 67/22; H04L 67/16; H04L 51/12; G06F 3/04842; G06F 3/04847

(57) ABSTRACT

In various example embodiments, a system and method for client management are presented. Inactive clients in the client population based on a lack of client use of a service offering for a predetermined period of time is determined. Customized electronic messages to the inactive clients are generated and sent. Timed subsequent electronic messages to clients who remain inactive after the receipt of the first electronic messages are further generated and sent. Statistics associated with client activity is calculated. The calculated statistics are caused to be displayed.

### CROSS-REFERENCE TO RELATED APPLICATIONS

This application claims the benefit of priority, under 35 U.S.C. Section 119(e), to Chet Brandenburg et al. U.S. Provisional Patent Application Ser. No. 62/067,550, entitled “Managing Client Information for Client Retention,” filed on Oct. 23, 2014 (Attorney Docket No. 3717.003PRV), which is hereby incorporated by reference herein in its entirety.

### TECHNICAL FIELD

Embodiments of the present disclosure relate generally to a client management system that generates and presents user interface providing functionality for client management.

### BACKGROUND

Service providers often provide various services to many clients at varying location and time. The flow of client participation shift and changes, making it difficult for service providers to manage and understand the source of the change. Excessive unstructured information in the way clients engage with the service provider impairs effective communication between a service provider and a client. Conventionally, a client may choose to participate with a service and end their participation, requiring the service provider to individually track the trend of each client in order to seek continual participation. The structure of individual tracking is inefficient use of client information for client management.

### BRIEF DESCRIPTION OF THE DRAWINGS

Embodiments are illustrated by way of example and not limitation in the figures of the accompanying drawings. Like reference numbers indicate similar elements.

FIG. 1 is a block diagram illustrating a networked system, according to some example embodiments.

FIG. 2 is a block diagram illustrating an example embodiment of a management system, according to some example embodiments.

FIG. 3 illustrates in block outline some operations of an example method for a management program, in accordance with an example embodiment.

FIG. 4 illustrates in block outline some operations of an example method for sending electronic messages, in accordance with an example embodiment.

FIGS. 5-10, 11A, and 11B illustrate example user interfaces for message customization, according to some example embodiments.

The headings provided herein are merely for convenience and do not necessarily affect the scope or meaning of the terms used.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense.

In various embodiments, the features of the present disclosure provide a technical solution to the technical problem of providing a user interface allowing for automatic customized interaction and management of clients. In some embodiments, a management system provides the technical benefit of client management using client information. Client management comes in the form of automatic generation of electronic messages using client information and triggered by message rules created by service providers. These electronic messages are customized to specific clients using information from client profile and online social network. For example, message rules can trigger automatically generated electronic message targeting clients who have upcoming appointments with the service provider, or clients who have remained inactive for a predetermined amount of time, and the like. These customized messages can be subsequently updated and further customized based on a detection of client interaction with previous messages.

Further, the management system accesses an online social network platform and identify individuals who are good potential candidates for specific service providers based on their information and connection to existing clients. The potential candidates can be identified through a combination of direct social network connections to current clients, the potential candidate's interest, location, and the like. Customized messages are generated and sent to these potential candidates. Moreover, the management system provides functionality to calculate and analyze client statistics for determining responsiveness of clients to specific electronic messages and thus gauge effectiveness of the messages. Subsequent interactions and customized messages are updated using the calculated client statistics.

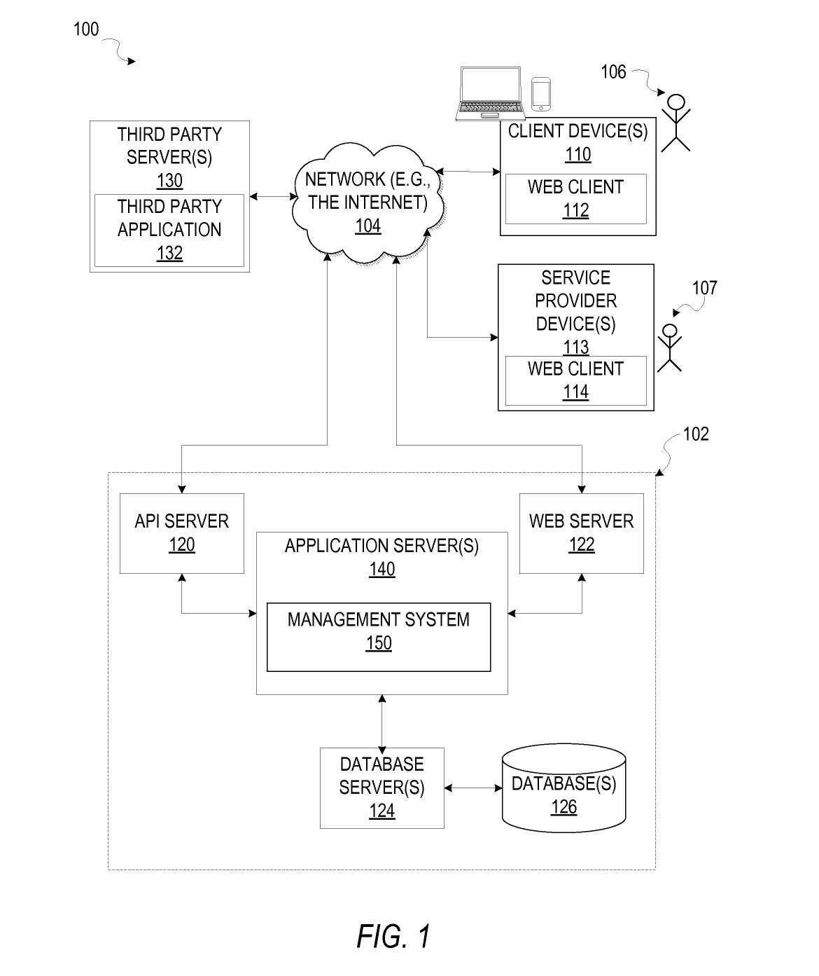

With reference to FIG. 1, an example embodiment of a high-level client-server-based network architecture 100 is shown. A networked system 102 provides server-side functionality via a network 104 (e.g., the Internet or wide area network (WAN)) to a client device 110 and service provider devices 113. In some implementations, users (e.g., user 106 and 107) interact with the networked system 102 using the client device 110 and service provider device 113, respectively. FIG. 1A illustrates, for example, a web client 112 and 114 (e.g., a browser, such as the Internet Explorer® browser developed by Microsoft® Corporation of Redmond, Wash. State) executing on the client device 110 and service provider device 113. The web client 112 and 114 accesses the various systems of the networked system 102 via the web interface supported by the web server 122. Although FIG. 1A shows one client device 110 and one service provider device 113, in other implementations, the network architecture 100 comprises multiple devices.

In various implementations, the client device 110 and service provider device 113 comprise computing devices that includes at least a display and communication capabilities that provide access to the networked system 102 via the network 104. The client device 110 and service provider device 113 comprise, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 and service provider device 113 comprise one or more of a touch screen, accelerometer, gyroscope, biometric sensor, camera, microphone, Global Positioning System (GPS) device, and the like.

The client device 110 and service provider device 113 communicate with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In various example embodiments, the client (e.g., the client 106) comprises a person, a machine, or other means of interacting with the client device 110. In some example embodiments, the client is not part of the network architecture 100, but interacts with the network architecture 100 via the client device 110 or another means. For instance, the client provides input (e.g., touch screen input or alphanumeric input) to the client device 110 and the input is communicated to the management system 150 via the network 104. In this instance, the networked system 102, in response to receiving the input from the client or a service provider, communicates information to the client device 110 and service provider device 113 via the network 104 to be presented to the user. In this way, the client and service provider can interact with the networked system 102 using the client device 110 and service provider device 113.

An Application Program Interface (API) server 120 and a web server 122 is coupled to, and provide programmatic and web interfaces respectively to, one or more application server(s) 140. The application server(s) 140 hosts one or more management system 150, each of which comprises one or more engines or applications and each of which can be embodied as hardware, software, firmware, or any combination thereof. The application server(s) 140 are, in turn, shown to be coupled to one or more database server(s) 124 that facilitate access to one or more information storage repositories or database(s) 126. The database(s) 126 also stores digital client information in accordance with some example embodiments.

In various example embodiments, the service provider (e.g., the service provider 107) comprises a person, a machine, or other means of interacting with the service provider device 113. The service provider 107 typically provides services that would be targeted towards the client 106. For example, such services can include “wellness services” such as include yoga, pilates, spinning, Zumba and similar group exercise classes, personal training, sports activities, massage and other spa treatments, meditation, nutrition counseling, as well as “alternative medicine” practices such as ayurveda, acupuncture and Chinese medicine. These services can be class or appointment based service available for the client 106 to sign up or make appointments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, registration, or payment functions that are supported by the relevant applications of the networked system 102.

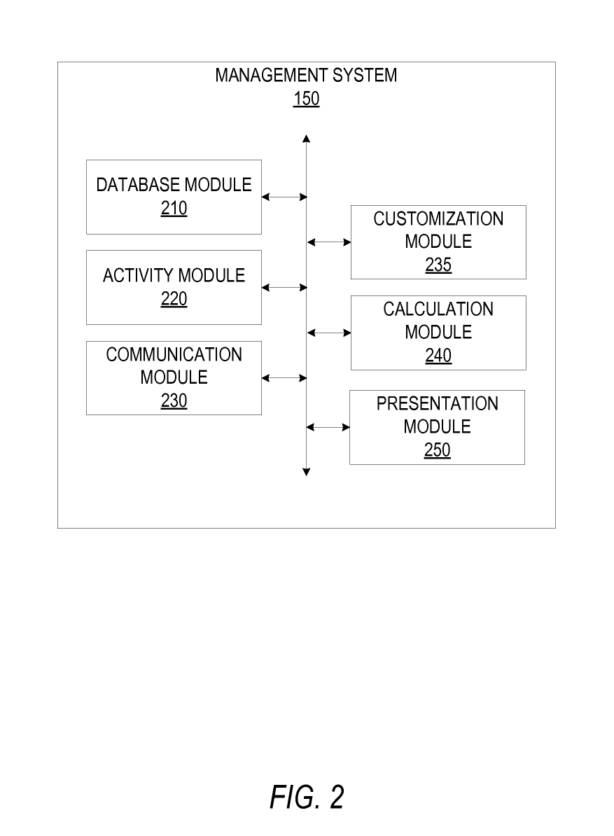

In some implementations, the management system 150 communicates with the client database 126 via the database server 124 and provides client information to a service provider. The client database 126 will typically be created and owned by a program operator, such as MindBody® Inc. The client database 126 is an aggregate of information about the client 106 and their activity of the service provider's 107 services which is described in more detail below. The management system 150 provides functionality to interactively manage and communicate with all clients. In some embodiments, the comparison system 150 communicates with the client device 110, service provider device 113, and the third party server(s) 130. The management system 150 will be discussed further in connection with FIG. 2 below.

Further, while the network architecture 100 shown in FIG. 1 employs a client-server architecture, the present inventive subject matter is, of course, not limited to such an architecture, and can equally well find application in a distributed, or peer-to-peer, architecture system, for example. The various systems of the applications server(s) 140 can also be implemented as standalone software programs, which do not necessarily have networking capabilities.

FIG. 2 is a block diagram of the management system 150 that provides functionality to manage the operations of a service provider. In example embodiments, the management system 150 provides interactive user interfaces allowing service providers to connect, interact with, and manage their past, current, and potential clients. The management system 150 includes a database module 210, an activity module 220, communication module 230, calculation module 240, and presentation module 250. All, or some, of the modules 210-250 of FIG. 2, communicate with each other, for example, via a network coupling, shared memory, and the like. It will be appreciated that each module of modules 210-250 can be implemented as a single module, combined into other modules, or further subdivided into multiple modules. Other modules not pertinent to example embodiments can also be included, but are not shown.

In various implementations, the database module 210 is configured to provide various data functionality such as exchanging information with databases or servers. In an example, the database module 210 provides functionality to store and access client records, where each client is associated with a unique identifier, channels of contact (e.g., such as an email address, phone number, and the like), and information and links to their social network profile. The database module 210 can receive client information directly from the clients during initial registration for a service with the service provider. Such client information can include their names, emails, phone number, and contact preferences. The database module 210 receives client information from social media platforms such as Facebook, Twitter, Instagram, and so forth. Further, the database module 210 stores and access service providers information including the type of services provided, locations, associated clients, and other information associated with each particular service provider.

In various embodiments, the communication module 230 is configured to perform various communication functions to facilitate the functionality described herein. For example, the communication module 230 provides network communication such as communicating with the networked system 102, the client device 110, service provider devices 113, and the third party server(s) 130. In various embodiments, the network communication can operate over wired or wireless modalities. Web services are intended to include retrieving information from the third party server(s) 130, the database(s) 126, and the application server(s) 140. In some implementations, information retrieved by the communication module 230 comprises data associated with the client (e.g., client profile information from an online account, social network service data associated with the client), data associated with the service providers (e.g., the type of services provided, the associated clients, associated instructors and schedules), or other data to facilitate the functionality described herein. In this way, the communication module 230 facilitates communication between the management system 150, the client devices 110, service provider device 113, and the third party servers 130 via the network 104.

In various embodiments, the activity module 220 provides functionality to determine the activity status of a client. The activity status depends on the activity level reflected by the engagement of the client with a service within a predetermined time period. The client is deemed to be active if the client either has visited the business or the client has booked a service or has made an appointment with the business. The client is deemed inactive if the client has not visited the business or booked a service or made an appointment with the business for a certain period of time, where the period of time is customizable according to the service provider's business. The activity module 220 determines an inactive client by detecting a client not attending a service or not having an active booked appointment with the service provider within a predetermine time period. The service provider can set the predetermined time period depending on the type of service. In an example, the predetermined time period to categorize a client with an inactive status for a yoga class can be set to one month, whereas for a hair salon hair coloring service can be set to four months.

In various embodiments, the activity module 220 access information of the client's friends to determine whether there is a match between the services that the friends and client attend. The activity module 220 first determines a person is a client's friend by accessing online social network information of the client or an address book imported by the client. Further, the activity module 220 determines others friends within the client's social network via access to their online social network information such as Facebook. The activity module 220 identifies whether the friend is also a client of the management system by performing a match with client information within the database 126. If the friend also is a client of the same service or a similar service attended by the client, the activity module 220 determines the activity status of the friend in a similar process. For instance, the client attends a Bikram yoga class located in San Jose, Calif., the activity module 220 can determine that a friend within the client's network also attends a Bikram yoga class offered by the same service provider located in Santa Clara, Calif. The similarity of the service can be determined by a category match between the service attended by the friend the service attended by the client. For instance, the service is Bikram yoga, which is categorized within the category yoga in the database 126, therefore all services categorized within the yoga category (e.g., including Bikram yoga, hot yoga, power yoga, and the like) would be considered a match. Further, the activity status of the friend associated with the Bikram yoga class in Santa Clara, Calif. is also determined. Similar to the activity status of the client, the friend is determined inactive if the friend have not attended a service or not having an active booked appointment with the service provider within a predetermine time period.

In various embodiments, customization module 235 generates a customized electronic message to be sent to an inactive client. The electronic message can include a customized message from the service provider to the targeted specific client through communication mediums such as email, text message, and social media notification. Message customization comes in the form of including specific information about the client gather from the database 126 and added incentives depending on the specific information about the client (e.g., such as how long the client has been inactive, identified change of location, and frequency of activity that the client has engaged in during the duration of being active). In an example, these customized messages can include an email or text containing a reminder to the targeted client that they have not used the service for a specified time period. A customized message can further have an incentive to re-engage the client with the service provider. The incentives include a discount, coupons to use the service, coupons for other establishments or items, or a trial period for a similar service that is owned by the same service provider.

The customization module 235 determines client preference to a specific category of service and providing discount to the determined preference. For example, a client is determined to have a preference for yoga classes based on detecting that the client has signed up to various yoga classes (e.g., Bikram yoga, hot yoga, and Hatha yoga) before becoming inactive. The customized message therefore can include an incentive directed to the specific client preference of discounts to a yoga class of the client's choice. Further, the customization module 235 determines others friends within the client's social network (via access to their online social network information such as Facebook) have attended or currently attending the hot yoga class that the client has attending. Based on the determination, the customized message can further include an interface for the user to invite the friend to attend the class together. If the friend is also in an inactive state, then a greater discount is offered to the client and the friend. A similar customized message is also generated to the inactive friend. If a client decides to make use of the discount, the information is stored within the database 126. Further, if the friend is active, a message is generated to be sent to the friend providing an option to invite the inactive client to attend the same service at the same time as the friend. In an example, the customized messages can include, “Hi Samantha, did you know your friend Sophie also attends Bikrim yoga class? Would you like to invite Sophie to attend your class?” In this example, Sophie is the inactive client, and Samantha is a friend determined to also attend Bikrim yoga class at a different location. If there is no response for a predetermined time period, a subsequent customized message can include the message and an incentive for both parties. The incentive can be for example, “We are offering a buddy discount, where if you invite a buddy along, you and your buddy can have 50% off your month pass! Would you like to invite your friend Sophie to attend and get a buddy discount?”

In various implementations, the customization module 235 determines whether an inactive client actively responds or shows interest to an electronic message. The customization module 235 detects client interest where the inactive client selects a link provided in the message, signs in on a client website, calls the service provider, or other shows some activity indicating the message has piqued the client interest in the service. Client interest indicates that the client remains curious and interested in the service but has not yet taken an action to actively re-engage with the services by actually booking an appointment. In response to client interest determination, the customization module 235 sends a subsequent customized message offering a targeted incentive based on client activity associated with client interest.

In various implementations, the customization module 235 continues to send subsequent customized messages if the client remains inactive. The time period of between subsequent customized messages being sent is predetermined based on the category of service provided or by the service provider. The time period between subsequent electronic messages can be longer when compared to the time period determined to send the first electronic message. For instance, the time period for which a client remains inactive before the communication module 230 sends out the first electronic message can be set for 3 months. In comparison, the time period for sending out subsequent electronic messages can be set for the five month mark. Of course, these time periods for sending out automatic electronic messages are customizable according to the service provider's business. When the targeted client switches from inactive to active, the communication module 230 stops sending out electronic messages that attempts to re-engage the targeted client. An inactive client or an inactive friend is deemed to be a recovered client if there is re-engagement with the service by visiting the service or makes an appointment for the service. Electronic messages for other purposes remain in effect, such as appointment reminders. The total amount of clients that have switched from inactive to active is then sent to the calculation module 240 for statistical analysis and further presented to the service provider. The statistical analysis of the total amount of clients in each category of active, inactive, switched from inactive to active is further discussed in detail in association with the calculation module 240 below.

In various implementations, the customization module 235 provides functionality to send electronic messages to active clients with reminders of upcoming appointments with a service provider, the electronic message having a selectable user interface allowing recipients to confirm their upcoming attendance. A client selecting the user interface triggers the confirmation within a service provider's appointment book, notifying the service provider of the confirmed upcoming attendance. In this way, the automatic process of sending confirmation, requesting confirmation, and notifying the service provider of the confirmation helps prevent no-shows for the service provider.

Electronic messages can include an appointment reminder via a user-selected or service-provider selected communication medium of choice such as text message, email, or social media notification. A service provider can customize the time before the actual appointment to send an electronic message appointment reminder to a client. For example, the service provider can choose to automatically send electronic message reminders to a client a few days before their actual appointment time. The electronic message can include a calendar attachment to allow the client to easily add the appointment information to their calendar. The electronic message can also include a carbon copy (e.g. CC) or blind carbon copy (e.g. BCC) to instructors or speakers in charge of leading the service provided. The user receiving the electronic message reminder will be presented with an option to confirm the upcoming appointment. Subsequent electronic messages can be sent to the client up until the day of the appointment until the client confirms the appointment. The client can confirm an appointment by clicking a link included in the electronic messages. Alternatively, the service provider has the option to choose an automatic confirmation when the electronic message is sent. If the client sends a responding electronic message to confirm the appointment, the appointment book will be marked accordingly. In response to a client appointment confirmation, the customization module 235 may automatically send a follow-up electronic message to thank the client, confirm the time and date of the appointment, and offer avenues to contact the business if the client has any further questions. The total number of confirmed and unconfirmed appointments is aggregated by the calculation module 240 to be present to the service provider. Alternatively, in response to an electronic message from the service provider, the client can send an electronic message back, expressing the client's desire to not receive any further messages. For example, the client can text back “STOP,” and the client will be unsubscribed from receiving further communications via text-messaging. The total number of confirmed and unconfirmed appointments is further discussed in the calculation module 240 below.

In various embodiments, the customization module 235 provides functionality to automatically update and fill up a service using a waitlist. In response to a spot opening in a class, the customization module 235 accesses the waitlist from the database, generates and sends an electronic message to the first client on the waitlist to notify them that they have been taken off the wait list and added to a class when space becomes available. The message can include an option for the newly added client to confirm their desire to attend the class by a specified date, else the client lose their spot. Where the client does not confirm by the specified date, the customization module 235 adds the next client on the waitlist. The operations of automatically update and fill up a service iterates until a class is full. For instance, the electronic message sent to a client to notify them they have been taken off the wait list and added to a class can include an attachment to allow the client to add the appointment to their calendar, including the time, date, and location of the appointment. Also, the client can be required reply to the message to accept or decline their spot in the class by sending a return message, calling the service to confirm, or selecting a selectable interface within the message to confirm, and the like. The total number of messages sent and spots accepted by clients as they are taken off the waitlist is calculated by the calculation module 240 and presented to the service provider. Optionally, the client can reply to the electronic message to unsubscribe from the messaging list.

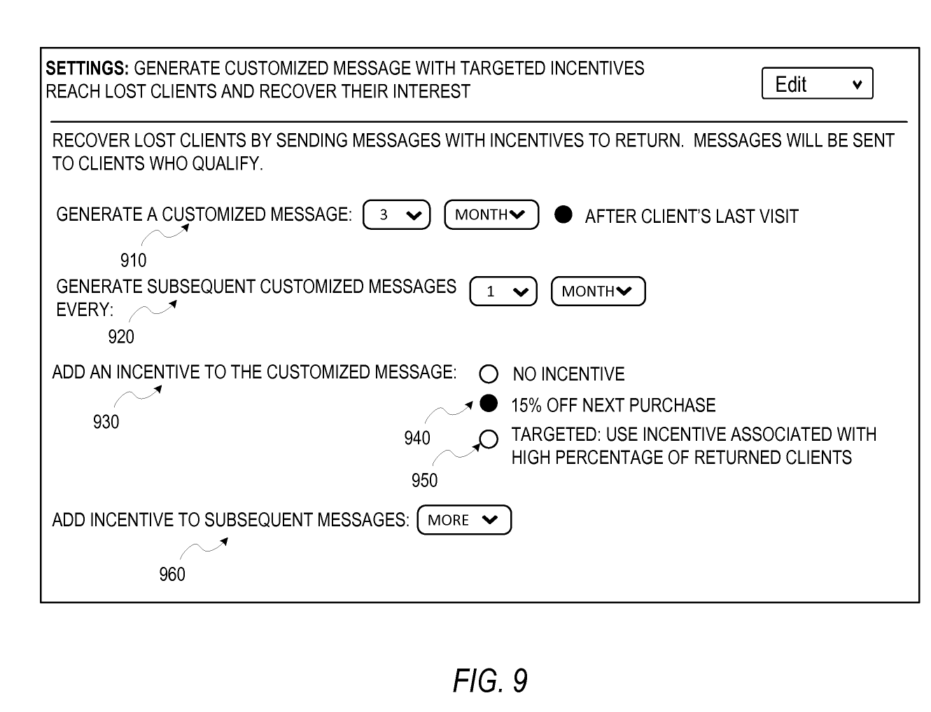

In various implementations, the calculation module 240 aggregates statistics taken from the database module 210, activity module 220, communication module 230 and, customization module 235 and calculate changes in the activities of the client. In some embodiments, the calculation module 240 calculate the total number of clients that have been recovered or returned. A client is deemed to have been recovered if the client has remained in an inactive state for at least a certain period of time, then switched to being active. A client is deemed to have been returned if the client was inactive then also switched to being active, where the inactive period of a returned client is shorter than compared to the inactive period of the recovered client. In other words, the client is determined to be a recovered client or returned client depending on the amount of time the client remained inactive. A client that has been inactive for a longer period of time is considered “lost” by the system in comparison to a client who has been inactive but not yet considered “lost.” A “lost” client that re-engages with the business by becoming active is considered “recovered” by the system. Whereas, an inactive client that re-engages with the business by becoming active is considered “returned” by the system. In an example, a client that has remained inactive for longer than one year is considered lost, whereas a client that has remained inactive for five months to one year is considered an inactive client. Any client that was lost but then become active in response to a message sent is considered recovered by the system. Any client that was inactive but then became active in response to a message sent is considered returned by the system. The statistics of recovered client and returned client are depicted in a user interface with associated incentives that contributed to changing the status on an inactive client. The user interface allows the service provider to select an associated incentive as the default customized message to more efficiently re-engage inactive clients. An example of this user interface is detailed in association with FIG. 9.

In connection with the recovered and returned clients, the calculation modules 240 also calculates the projected revenue that the business would make based on the returned and recovered clients. The projected revenue is calculated by taking the average dollar-amount that a client, specific to the service that the business provides, spends in a certain period of time (for example 3-month), multiplied by the amount of returned or recovered clients. As a result, the projected revenue yields the total dollar-amount that the returned or recovered clients would spend at the specific business. Also, the calculation module 240 can calculate the total number of emails sent to all the inactive clients. The results of these statistics are presented to the service providers to allow the service providers to track the path of their business.

In various embodiments, the calculation module 240 provides functionality to calculate the average time it takes for a client to switch from inactive to active, including average times for both returned clients and recovered clients. The average time is takes for a client to be considered “returned” is referred to as the average return time. The average time is takes for a client to be considered “recovered” is referred to as the average recovery time. The average return and recovery times are calculated based on the time between when the email is sent and the time when the clients re-engages with the business by either visiting the business or booking a service or an appointment with the business. Further, the calculation module 240 also determines the average time for a client to be deemed as returned or recovered and the associated incentives used to effectuate the result. Where the calculation module 240 determines a high correlation between a substantially short amount of time for a client to be deemed returned or recovered, then the calculation module 240 identifies the associated incentive that was able to elicit a high correlation with a short amount of time for a returned or recovered client. The customization module 235 can use the associated incentive to customize subsequent messages. The results of these statistics are presented to the service providers to allow the service providers a way to track the path of their business.

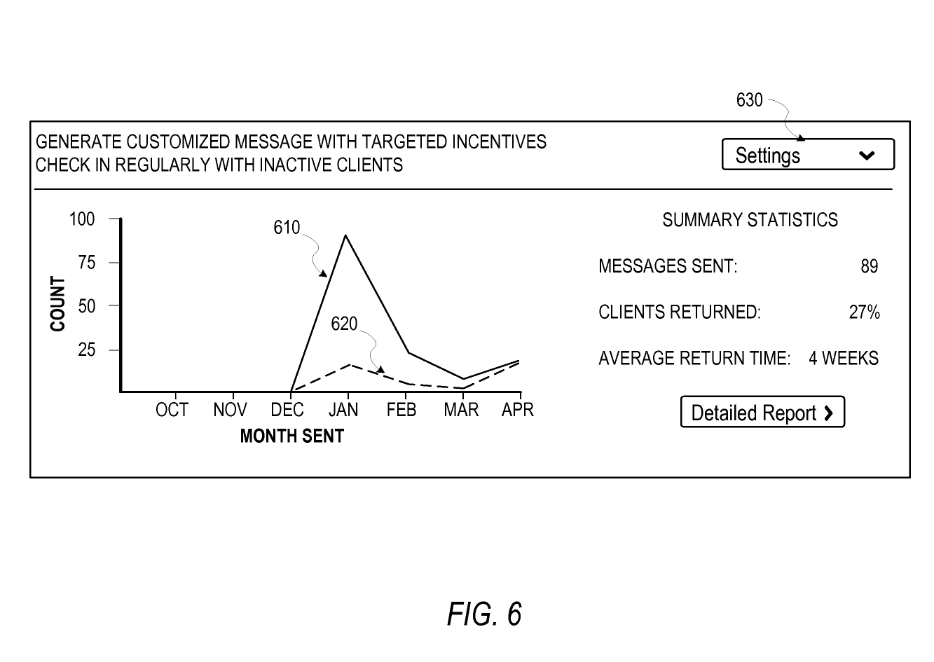

In various implementations, the presentation module 250 provides various presentation and user interface functionality operable to interactively present and receive information from the user. For instance, the presentation module 250 can cause presentation of various notifications or interactive user interfaces to the service providers an option to view client statistics and connect with the clients based on the viewed statistics. The presentation module 250 can present the statistics calculated by the calculation module 240. For instance, the presentation module 250 presents the number of clients that have been recovered, the number of clients that have been returned, the average time it took for clients to be recovered or returned, the number of electronic messages sent to the clients, and the like. In other embodiments, the presentation module 250 presents automatically generated interactive electronic messages to clients based on rules predefined by service providers. Example interfaces presented to the service provider 1007 at the service provider device 113 can be seen in FIG. 6-FIG. 14B. The interfaces presented at the service provider device 113 are further discussed below.

In various implementations, the presentation module 250 presents or causes presentation of information (e.g., visually displaying information on a screen, acoustic output, haptic feedback). Interactively presenting information is intended to include the exchange of information between a particular device and the user via a user interface. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 250 provides many other user interfaces to facilitate functionality described herein. Further, it will be appreciated that “presenting” as used herein is intended to include communicating information or instructions to a particular device that is operable to perform presentation based on the communicated information or instructions.

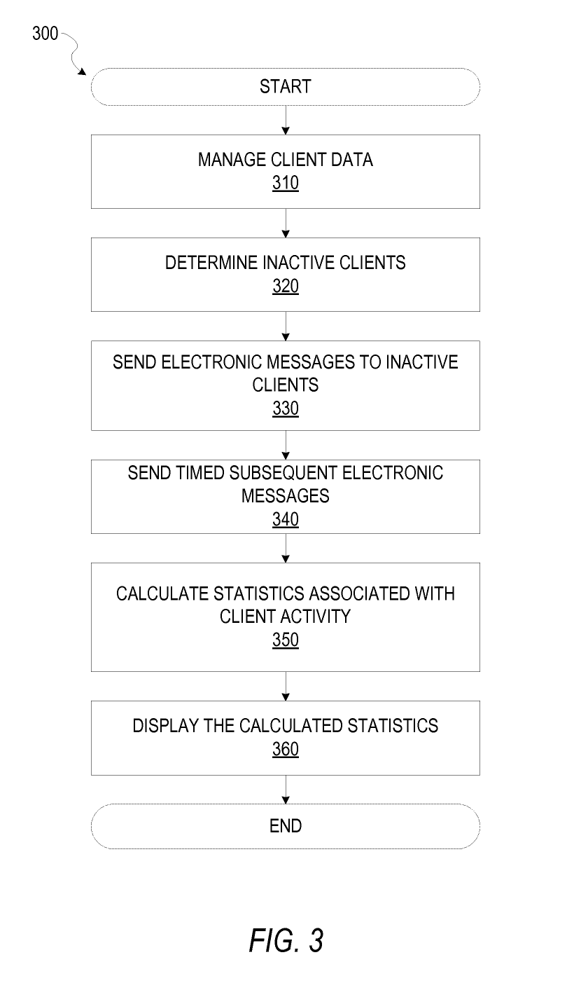

FIG. 3 is a flowchart illustrating a method 300 for client management in accordance with some embodiments. The operations of the method 300 may be performed by the service provider device 113, client device 110, management system 150, and/or a server included in the networked system 100 (e.g., database server 124). The operations may be performed by modules (e.g., database module 210, activity module 220, communication module 230, customization module 235, calculation module 240, and presentation module 250). The various operations of the method 300 may be performed in a different order and the method 300 may include only some of the operations described below.

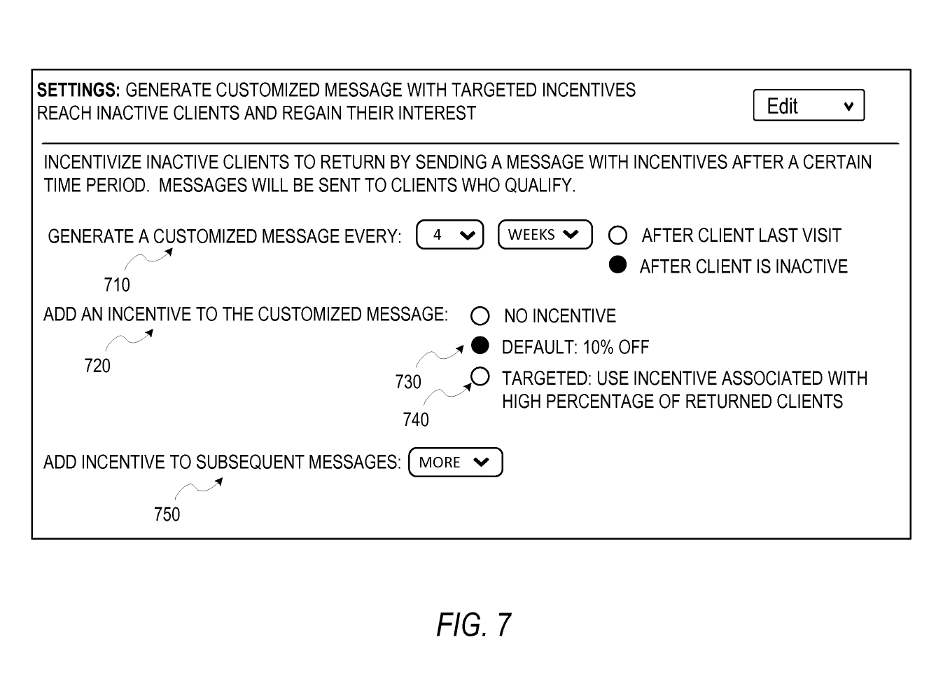

At operation 310, client information is received by the date module 210 from the client device 110, managed and stored in client database 126. At operation 320, the activity module 220 determines the total number of clients that have been inactive for a certain period of time. The client is deemed inactive if the client has not visited the business or booked a service or made an appointment with the business for a certain period of time, where the period of time is customizable according to the service provider's business. The customization of determined inactivity is discussed in further detail in association with FIGS. 7 and 9.

At operation 330, the customization module 235 generates and sends customized electronic messages to the determined inactive clients. These customized electronic messages can include incentives for the clients to re-engage with the business. Optionally, the message can further include incentives for the client and a friend of the client from an online social media network, the friend identified to be also interested in the service based on the friend's online profile and the friend's profile with the management system 150. At operation 340, the customization module 235 generates and sends timed subsequent electronic messages to clients who remain inactive after the receipt of the first electronic messages. These timed subsequent electronic messages can also include an incentive targeted to the client. The customization module 235 identifies the incentive associated with the highest percentage of clients recovered or returned. In other words, incentives can be categorized by how many clients have been recovered or returned using the particular incentive. An incentive that is associated with a high amount of clients who used the incentive to return is then subsequently included in time subsequent messages. Such a targeted incentive more efficiently re-engages client who were considered inactive or lost.

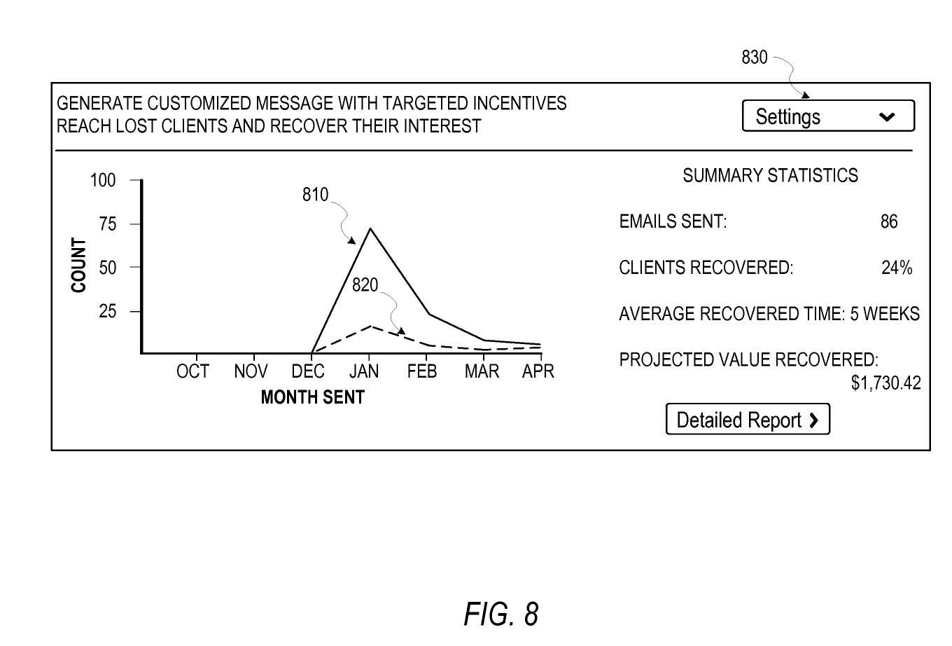

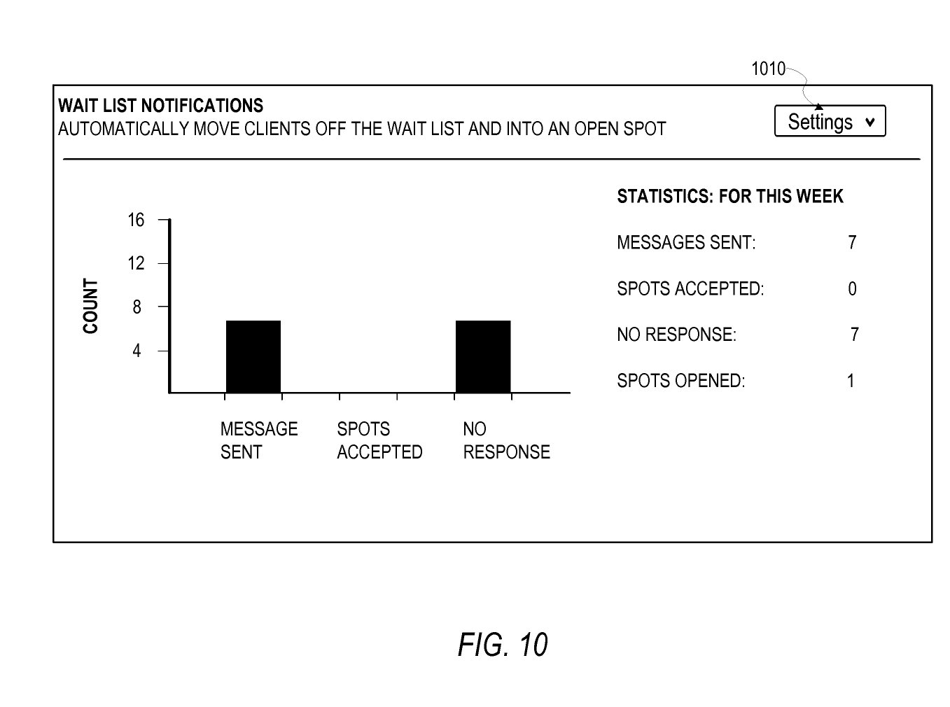

At operation 350, the calculation module 240 calculates statistics associated with client activity, the statistics may include the total number of clients that have switched from inactive to active as a result of the electronic messages. These statistics include for example, percentage of clients that have switched from inactive to active, average time it took for the clients to switch, projected revenue, and the like. At operation 360, the presentation module 250 causes display of the calculated statistics which can be in graph format or numerical format. Examples of such a display is shown and discussed in detail in association with FIG. 6, FIG. 8, and FIG. 10. The method may comprise further operations, including other aspects of functionality and features of the management program described herein.

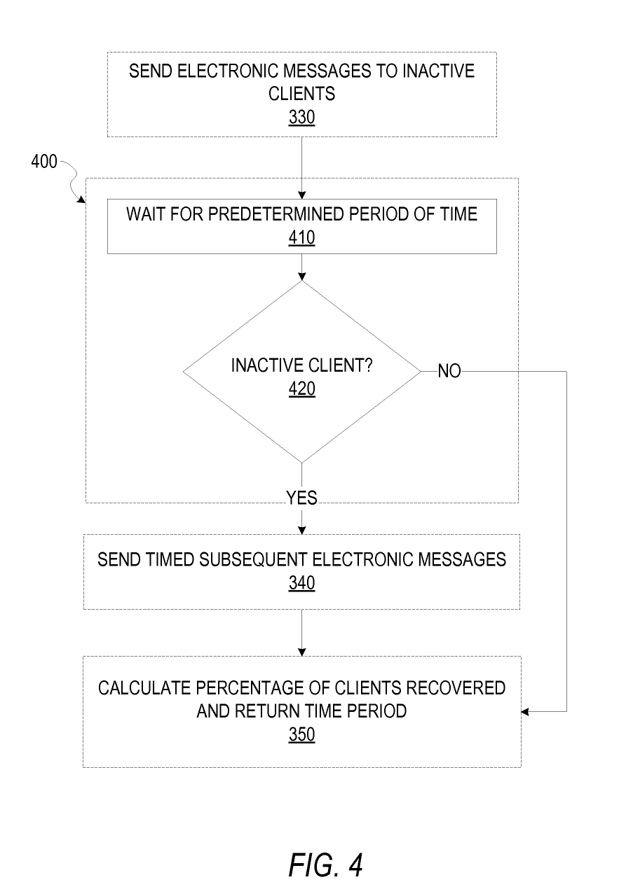

In some embodiments, as shown in FIG. 4, at operation 410, waiting for a predetermined period of time before sending subsequent electronic messages. After the first electronic message is sent out to inactive clients at operation 330, the service provider can choose how long to wait before sending out subsequent electronic messages if the client remains inactive. For example, the service provider can choose to send out an electronic message to clients who have been inactive for a month, then select to send automatic electronic messages each month afterwards if the clients remain inactive. At operation 420, when the predetermined time period has elapsed, if the client remains inactive, then subsequent electronic messages are sent out to those clients at operation 340. However, if the client has switched from being inactive to active, then subsequent electronic messages will not be sent to these now active clients. The clients that have switched to active will be categorized as “returned clients” or “recovered clients.”

### Example User Interfaces

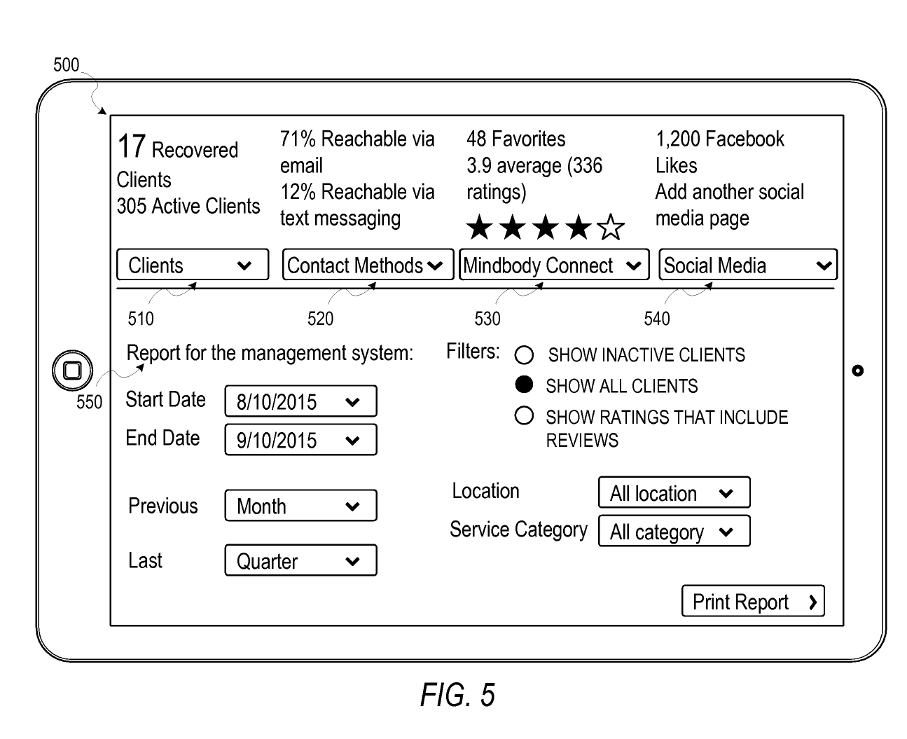

FIGS. 5-11B illustrate some example screenshots that can be presented in one or more of the interfaces described above. The interfaces can be presented in a computer monitor, wireless device, portable device, wearable computer, cellular or mobile phone, Personal Digital Assistant (PDA), smart phone, tablet, ultrabook, netbook, laptop, and so forth. The screenshots depict example aspects of the management program 100 that facilitate execution of the program for service providers to connect and engage their clients. Although FIGS. 5-11B depict specific example user interfaces and user interface elements, these are merely non-limiting examples and many other alternate user interfaces and user interface elements can be generated by the presentation module 250 and presented to the user. It will be noted that alternate presentations of the displays of 5-11B include additional information, graphics, options, and so forth; other presentations include less information, or provide abridged information for easy use by the user.

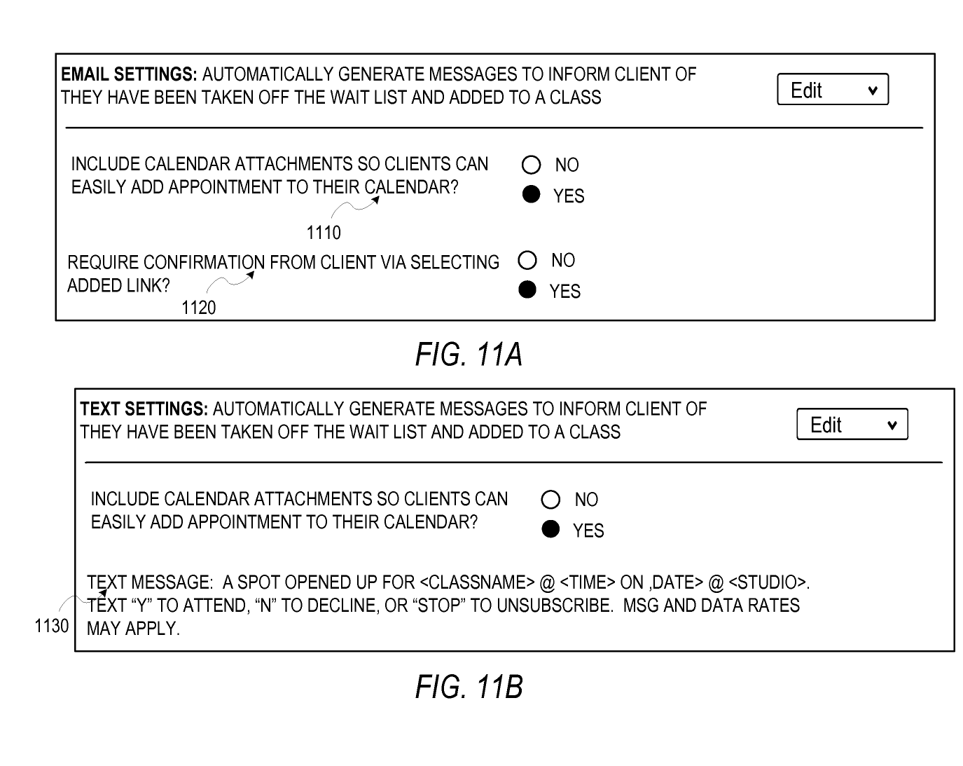

For example, in FIG. 5 an example user interface 500 presents management features that can include client statistics and information 510, contact methods 520, MINBODY connect 530, and online social media 540. The statistics in client information 510 can be calculated by calculation module 240 accessing data from database module 210. Further detailed client information can be accessed by the service provider device 113 by selecting client information 510. Details of client information 510 regarding returned and recovered clients can be viewed in FIG. 6 and FIG. 8 discussed in further detail below. Contact method 520 presents statistics of clients who can be accessible through electronic messages, such as email or text messaging. Service providers can choose to contact selected clients by selecting the contact method 520 interface. In response to selecting contact method 520, the management system can prompt the service provider to select which types of clients to contact, methods of contact, and the kind of information the business wish to provide to the clients. The various types of setting selection is described below in FIG. 7, FIG. 9, FIG. 11A, and FIG. 11B. The MINDBODY connect selection 530 allows service providers to access ratings of the management system 150. For example, out of all the users, there has been 336 users who have rated the management system 150, giving a 3.9 average out of a five total rating with 48 users adding the system as a favorite. Further selection 530 allows users to access reviews and comments added by other users for further details in the workings of the system. Social media 540 allows service providers to add online social media information about their services to be used for customized message generation. Service providers can add their online social media accounts, such as Facebook, Instagram, SnapChat, and the like. Adding online social media accounts gives them access to people who are connected to them via those accounts, therefore access to information about current or potential clients for the service provider. Additionally, a report of the updates, status, and results of the management system 150 can be generated via selectable interface 550. A service provider can customize what is seen in a report of the management system including the dates of the information, the filters of what kind of information is included in the report along with the location and service category since many service providers have multiple services at multiple locations.

FIG. 6, FIG. 8, and FIG. 10 illustrate example interactive user interfaces regarding client information in a structured format represented by statistical calculations and graphical form. For example, in FIG. 6, the service provider can view the total number of emails sent to the clients who have been inactive for a certain period of time, the total number of clients that have returned based on those emails being sent, and the average time is took the clients to return. These statistics can also be shown in a graphical format for ease of view (for example, line graphs, bar graphs, pie graphs, and the like). Line graph 610 represents the trend of customized messages that were sent to clients who were determined to be inactive. Selecting line graph 610 causes display of the information associated with the messages sent, client recipients of those messages, the clients who returned from those messages, and the associated incentives to each client. The associated incentives can be further structured and presented based on the number of clients who returned using the incentives. Line graph 620 represents the trend of clients that have returned based on the customized messages sent. Selecting line graph 620 causes display of information associated with the trend of returned clients such as the associated incentives that were used when the client returned, the time it took between the first message being sent to the time the client returned, the number of messages sent before returning, and the like. Selecting selectable interface 630 allows for control of customizing messages sent to inactive clients. Details regarding customization of messages sent to inactive clients is further detailed in FIG. 7. As FIG. 8 illustrates, the service provider can view the total number of emails sent to the clients who have been deemed lost, the total number of clients that have been recovered, the average time it took the clients to be recovered, and the projected revenue that the business would make based on the total number of recovered clients. These statistics can also be shown concurrently in a graphical format (for example, line graphs, bar graphs, pie graphs, and the like). Line graph 810 represents the trend messages that were sent to lost clients, lost clients being clients that have remained inactive for a period of time longer than that of inactive clients. Line graph 820 represents the trend of clients that have been recovered based on the customized messages sent to the lost clients. Selecting selectable interface 830 allows for control of customizing messages sent to the lost clients. Details regarding customization of messages sent to lost clients is further detailed in FIG. 9.

FIG. 10 illustrates an example interactive user interface for wait list notifications. The service provider can view the total number of text messages or emails sent to clients who have signed up for the waitlist, the total number of clients that have accepted, and the total number of clients that have not responded. Electronic messages can be sent to clients in response to a spot being opened and ready for the client to join, or a notification that the client has moved up in the waitlist line. These statistics can also be shown concurrently in a graphical format (for example, line graphs, bar graphs, pie graphs, etc.). The service provider may choose to set up the way messages are sent and the requirements for a client to accept being added to a wait list by selecting settings interface 1010. Further details regarding the settings interface 1010 is detailed in association with FIG. 11. Furthermore, the service provider can view the total number of text messages or emails sent to clients who have upcoming appointments, the total number of clients who have confirmed their appointments, and the total number of clients who have not yet confirmed their appointments. The service provider can choose to re-send appointment reminders to clients who have not yet confirmed their appointments within a certain period of time. These statistics can also be shown concurrently in a graphical format (for example, line graphs, bar graphs, pie graphs, etc.).

FIG. 7, FIG. 9, FIG. 11A, and FIG. 11B illustrate interactive user interface for control of message customization. FIG. 7 illustrates an interactive user interface for controlling the generation of customized messages for inactive clients with the goal for them to be returned. At selection 710, a service provider can choose the duration of time that has lapsed to trigger an automatic electronic message to be generated and sent to the client. Further, the lapsed time can be triggered either after the client is deemed inactive or after the client's last visit. Moreover, selection 720 provides a customization to include an incentive for the client to return, such as a discount coupon that has an expiration date. The incentive can be a set default 730 for all clients, or can be a targeted incentive 740 where the incentive can change according to the incentives used that were able to successfully obtain the highest percentage of returned clients. In other words, targeted incentive 740 sends the incentive that was determined to be associated with the highest rate (or highest percentage) of returned clients in the past. Accordingly, the targeted incentive being sent can change according to how it has performed in incentivizing past inactive clients to return. Selection 750 provides a customization to include different incentives to subsequent messages. If there is no selection at selection 750, then the default first selection 720 incentive is used for subsequent messages. However, the subsequent messages can differ from the incentive selection 720. For example, subsequent incentive selection 750 can include a higher default incentive of 15% off, or can include online social media aspect of inviting a friend to also attend a class, as discussed in detail above in association with FIG. 2.

FIG. 9 illustrates an interactive user interface for controlling the generation of customized messages for lost clients with the goal for the clients to be recovered. At selection 910, a service provider can choose the time frame that has lapsed to trigger an automatic message to be generated and sent to lost clients. In one example, the customized message is generated three months after the client has last visit. I other words, this selection allows the service provider to determine the time frame lapse to trigger the client being deemed as lost. In this example, the client would be deemed lost three months after the client's last visit. Moreover, selection 920, provides customization of the time frame to send subsequent customized messages after the first customized message is generated at selection 910. In this example, after three months after the client's last visit, if the client continues to be inactive, then subsequent messages are generated and sent every one month. At incentive selection 930, the service provider can include an incentive to be added to the customized message, such as a discount coupon 940 with an expiration date. Other incentives can include a targeted incentive 950 where the incentive can change according to the incentives used that were able to successfully obtain the highest percentage of lost clients. Selecting targeted incentive 950 includes the incentive that was determined to be associated with the highest percentage of recovered clients. These incentives are used due to a determined highest successful rate of recovering clients from the lost status. Alternatively, the service provider may include other incentives that they individually self-customize. Selection 960 provides a customization of different incentives in subsequent messages being generated at 920. It is recognized that once an incentive is offered at selection 930 with no response from the customer, and no interest is determined, then a different incentive should be included during subsequent messages. These incentives offered at subsequent incentive selectin 960 is more targeted based on the client profile information and their online social media information. In one example, the subsequent incentive selection 960 can include a higher discount rate for both the client and a friend of the client (the friend determined from their online social media identified to be also interested in the service). In other words, a buddy discount can also be included at subsequent incentive selection 960.

FIG. 11A illustrates an interactive user interface for controlling the generation of customized email messages informing clients of a status relating to a waitlist. The service provider can customize a message to notify a client that they have been taken off the wait list and added to a class, when there is an opening in the class. The electronic message can also include the option 1110 for the client to add the appointment to their calendar. The electronic message can also allow the client to accept being added to the class, or decline. Optionally, the message can require confirmation section 1120 from the client by selecting an offered link within the message. The confirmation may require the client to confirm their new status by a certain date, else they will not be added to the class. FIG. 11B illustrates an interactive user interface for controlling the generation of customized text messages informing clients of a status relating to a waitlist. Many options added within the email is also added in the text messages. Selection interface 1130 allows the service provider to customize their own text message to include the class name, time, date, and the studio location. Further, the client has the option to text back to confirm their new status being added to the class. In some embodiments, the service provider can send the electronic message from a “business mode.” The guided user interfaces has two core modes of operation, namely a “business mode” and a “consumer mode”, and provides corresponding business mode and consumer mode user interfaces. The business mode interfaces provide business mode users (for example, owners, managers, and staff at the service provider's business) with front and back office functionality for performing and managing core operations of their businesses. The business mode users can include the service providers 107 mentioned above. The consumer mode interfaces provide customer mode users (e.g., clients of the service providers or subscribers to the management system 150, such as MINDBODY Online) with online access to MINDBODY Online in order to manage their accounts, payments, and schedules. Customer mode users can include the clients 106 mentioned above. Further, a service provider can customize to remind a client about an upcoming appointment. For example, the service provider has the option of selecting how many days before the scheduled appointment to send the electronic reminder, where the electronic reminder includes the time, date, and location of the appointment. The teacher who leads the class can also be provided a carbon copy of the electronic message. The electronic message can also include the option for the client to add the appointment to their calendar. Optionally, the electronic message can require the client to confirm the appointment by taking additional steps such as clicking on a link included in the message.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

Thus, systems and methods for management programs have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A system comprising:
one or more processors and a memory including instructions, which when executed by the one or more processors, cause the one or more processors to perform operations comprising:
determining inactive clients in the client population based on a lack of client use of a service offering for a predetermined period of time;
sending electronic messages to the inactive clients;
sending timed subsequent electronic messages to clients who remain inactive after the receipt of the first electronic messages;
calculating statistics associated with client activity; and
causing display of the calculated statistics.

2. The system of claim 1, further comprising:
calculating a percentage of clients recovered within a second predetermined period of time period, the percentage of clients recovered being based on a determination of clients switching from inactive to active use of the service offering.

3. The system of claim 2, wherein the timed subsequent electronic messages include an incentive targeted to the client and further comprising:
identifying the incentive associated with the highest percentage of clients recovered; and
the time subsequent electronic messages including the identified incentive.

4. The system of claim 2, wherein the calculated statistics further include calculating a return time period for the clients to switch from inactive to active state.

5. The system of claim 4, wherein the calculated statistics further include calculating a projected revenue based a total amount of clients recovered and a service cost of the service offering.

6. The system of claim 4, further comprising:
generating a graph displaying a total number of the electronic messages sent and a total number the clients recovered.

7. The system of claim 1, further comprising:
using the inactive client's online social media information, identify a friend of the client's online social media network interested in the service offering; and
wherein the timed subsequent electronic message includes a discount for both the specified friend and the client.

8. The system of claim 1, further comprising:
using the inactive client's online social media information, identify a friend who is also an active client of a service provider; and
sending a customized message to the friend providing an option for the friend to invite the inactive client to participate in a second service offering associated with the friend.

9. The system of claim 8, wherein the second service offering is determined to be in the same category as the service offering associated with the client.

10. A computer-implemented method comprising:
maintaining, by a computing device comprising one or more processors, a client database containing data about a client population and including data relating to electronic messages sent to and received from the client population;
determining, by a computing device comprising one or more processors, inactive clients in the client population based on a lack of client use of a service offering for a predetermined period of time;
sending, by the computing device comprising one or more processors, electronic messages to the inactive clients;
sending timed subsequent electronic messages to clients who remain inactive after the receipt of the first electronic messages;
calculating statistics associated with client activity; and
causing display of the calculated statistics.

11. The method of claim 10, further comprising:
calculating a percentage of clients recovered within a second predetermined period of time period, the percentage of clients recovered being based on a determination of clients switching from inactive to active use of the service offering.

12. The method of claim 11, wherein the timed electronic messages include an incentive targeted to the client and further comprising:
identifying the incentive associated with the highest percentage of clients recovered; and
the timed subsequent electronic messages including the identified incentive.

13. The method of claim 11, wherein the calculated statistics further include calculating a return time period for the clients to switch from inactive to active state.

14. The method of claim 13, wherein the calculated statistics further include calculating a projected revenue based a total amount of clients recovered and a service cost of the service offering.

15. The method of claim 13, further comprising:
generating a graph displaying a total number of the electronic messages sent and a total number the clients recovered.

16. The method of claim 10, further comprising:
using the inactive client's online social media information, identify a friend of the client's online social media network interested in the service offering; and wherein the timed subsequent electronic message includes a discount for both the specified friend and the client.

17. The method of claim 10, further comprising:
using the inactive client's online social media information, identify a friend who is also an active client of a service provider; and
sending a customized message to the friend providing an option for the friend to invite the inactive client to participate in a second service offering associated with the friend.

18. The method of claim 17, wherein the second service offering is determined to be in the same category as the service offering associated with the client.

19. An interactive user interface for a client management system having access to at least one client information database, the user interface comprising:
at least one processor to implement the interactive user interface;
a first user interface element allowing selection of data stored in the at least one client information database;
a second user interface element allowing selection of a method of communication with the clients based on the selection of the data stored;
a third user interface element allowing selection of a method of communication with clients through online social media platforms; and
a fourth user interface element allowing identification of
a total amount or percentage of clients recovered within a predetermined period of time period, the total amount or percentage of clients recovered being based on a determination of clients switching from inactive to active use of the service offering,
a return time period for the clients to switch from inactive to active state, and
a projected revenue based on the total amount of clients recovered.

20. A machine-readable medium having no transitory signals and storing instructions that, when executed by at least one processor of a machine, cause the machine to perform operations comprising:
determining inactive clients in the client population based on a lack of client use of a service offering for a predetermined period of time;
sending electronic messages to the inactive clients;
sending timed subsequent electronic messages to clients who remain inactive after the receipt of the first electronic messages, the timed subsequent electronic messages including an incentive targeted to the client;
calculating a percentage of clients recovered within a second predetermined period of time period, the percentage of clients recovered being based on a determination of clients switching from inactive to active use of the service offering;
identifying the incentive associated with the highest percentage of clients recovered; and
including in the timed subsequent electronic messages the identified incentive.
